(19) United States
(12) Patent Application Publication
(10) Pub. No.: US 2005/0279207 A1
(43) Pub. Date: Dec. 22, 2005

(54) Liquid delivery system

(75) Inventors: Kevin T. O'Dougherty, Arden Hills, MN (US); Robert E. Andrews, Hudson, MA (US); John Titus, Lonsdale, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Advanced Technology Materials, Inc., Danbury, CT (US)

(21) Appl. No.: 10/869,238

(22) Filed: Jun. 16, 2004

(51) Int. Cl. B01D 19/00

(52) U.S. Cl. 95/241

(57) ABSTRACT

The present invention is a method for delivering liquid that minimizes the formation of microbubbles in the liquid, and a system for the same. The method entails supplying liquid from a fluid container into a flow path. The liquid is delivered through the flow path to a downstream process while maintaining the liquid at a pressure that inhibits formation of microbubbles in the liquid.

### CROSS-REFERENCE TO RELATED APPLICATION(S)

This application is related to a co-pending application filed on even date and entitled “Collapsible Fluid Container,” which is incorporated herein by reference.

### BACKGROUND OF THE INVENTION

The present invention relates generally to the field of liquid delivery systems for use in industrial process applications. In particular, the present invention relates to a liquid delivery system that minimizes the formation of gas microbubbles in chemical liquid streams.

In many industrial process applications, fluid containers are employed as a source of process liquids for liquid delivery systems. Oftentimes the fluid containers are fabricated and filled at locations remote from the end-use facility. In such situations, the end-use facility then either directly incorporates the fluid containers into a liquid delivery system or empties the liquid from the fluid containers into a reservoir connected to the liquid delivery system.

In certain industrial process applications, the presence of gas microbubbles in liquid traveling through a liquid delivery system may have harmful effects. For example, when liquids are deposited on a substrate to form a layer, the presence of microbubbles in the deposited liquids may cause defects in the deposited layer or subsequent deposited layers. In the semiconductor industry, for example, a common manufacturing step in producing integrated circuits involves depositing photoresist solution on silicon wafers. The presence of microbubbles in the photoresist solution will typically yield defect sites on the surface of the wafer in subsequent process steps. As features on integrated circuits have continued to become smaller, the presence of microbubbles has posed an increasing danger to the quality of integrated circuits. Moreover, when microbubbles are observed in industrial liquid delivery systems, the systems are often purged until the microbubbles are eliminated, which can result in the wasting of expensive chemical liquids. Thus, it is advantageous to eliminate, or at least minimize, the presence of microbubbles in liquid delivery systems.

Although it is known that the presence of microbubbles in liquids deposited on substrates in industrial process applications can cause defects in subsequent process steps, the mechanism of microbubble formation is not well understood. Given these problems associated with formation of microbubbles, there is a need for a system and a method for storing and delivering liquids that reduces microbubble formation.

### BRIEF SUMMARY OF THE INVENTION

The present invention is directed to a method and a system for delivering liquid from a fluid container to a downstream process while inhibiting microbubble formation. The present invention is based on the discovery that microbubble formation in a flow path of a liquid delivery system can be inhibited by preventing a pressure in the flow path from falling below a pressure under which the liquid was equilibrated with gas.

The present invention includes a method for delivering liquid from a fluid container to a downstream process. The method comprises supplying the liquid from the fluid container into a flow path. The liquid is delivered through the flow path to the downstream process while maintaining the liquid at a pressure that inhibits formation of microbubbles in the liquid.

The present invention further includes a system for delivering liquid to a downstream process that minimizes formation of microbubbles in the liquid. The system includes a fluid container for storing the liquid. A flow path communicates with the fluid container. The flow path has an inlet end communicating with the fluid container and an outlet end communicating with a downstream process. A means for increasing a pressure inside the liquid delivery system is included to generally prevent the liquid from being subjected to a pressure that induces microbubble formation.

### BRIEF DESCRIPTION OF THE DRAWINGS

FIG. 1 is a block-diagram representation of a liquid delivery system.

FIG. 2 is a block-diagram representation of the liquid delivery system of FIG. 1 including a pump.

FIG. 3A is a block-diagram representation of the liquid delivery system of FIG. 1 including an elevated fluid container.

FIG. 3B is a block-diagram representation of the liquid delivery system of FIG. 1 including a mechanical force applicator.

FIG. 3C is a block-diagram representation of the liquid delivery system of FIG. 1 including a fluid pressure applicator.

FIG. 4 is a schematic representation of an experimental liquid delivery system.

FIG. 5 is a graph of the particle/microbubble distribution from the experimental liquid delivery system of FIG. 4 having 5 feet of hydraulic head.

FIG. 6 is a graph of the particle/microbubble distribution of the experimental liquid delivery system of FIG. 4 having −3 feet of hydraulic head.

FIG. 7A is a perspective view of a portion of the experimental liquid delivery system of FIG. 4 that includes the fluid container.

FIG. 7B is a perspective view of the portion of the experimental liquid delivery system of FIG. 7A with a dead weight placed atop the fluid container.

FIG. 8 is a cross-sectional view of a fluid container equipped with an air pressure means for dispensing liquid from the fluid container.

FIG. 9A is a front view of a zero-headspace collapsible liner.

FIG. 9B is a cross-section taken along line 9-9 of FIG. 9A

FIG. 10A is a front view of a zero-headspace collapsible liner equipped with a gas-trapping auxiliary chamber.

FIG. 10B is a cross-section taken along line 10-10 of FIG. 10A prior to sealing off the gas-trapping auxiliary chamber.

FIG. 10C is a cross-section taken along line 10-10 of FIG. 10A after sealing off the gas-trapping auxiliary chamber.

FIG. 11A is a front view of a zero-headspace collapsible liner having a dispensing chamber and a collection chamber.

FIG. 11B is a cross-section taken along line 11-11 of FIG. 11A prior to sealing off the collection chamber.

FIG. 11C is a cross-section taken along line 11-11 of FIG. 11A after sealing off the collection chamber.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principles of the invention. The figures may not be drawn to scale. Like reference numbers have been used throughout the figures to denote like parts.

### DETAILED DESCRIPTION

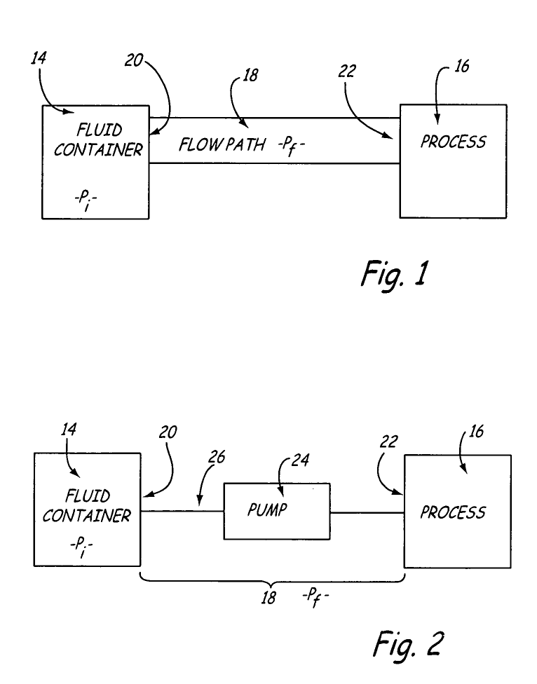

The present invention is directed to both a method and a system for delivering liquid along a flow path to a downstream process while inhibiting microbubble formation. FIG. 1 shows a block-diagram representation of a liquid delivery system of the present invention. As shown in FIG. 1, a liquid delivery system includes a fluid container 14 that communicates with a downstream process 16 via a flow path 18. Liquid is supplied from fluid container 14 into an inlet end 20 of flow path 18 and delivered along flow path 18 to an outlet end 22 of flow path 18, which communicates with downstream process 16.

It is well known that gas can dissolve in liquids in a physical manner, without chemical reactions or interactions. Gas that dissolves in liquid without undergoing chemical reactions or interactions may come out of solution and form microbubbles if the solubility of the gas in the liquid decreases. The total volume of gas that will dissolve in a liquid under equilibrium conditions depends upon the composition of the liquid, the composition of the gas, the partial pressure of the gas, and the temperature. If the composition of the liquid and the gas is fixed, and the temperature remains constant, the solubility of a gas in the liquid is directly proportional to the pressure of the gas above the surface of the liquid. Unless otherwise specified, the term “gas” is intended herein to include atmospheric air, as well as any other gas or combination of gases.

The liquid in fluid container 14 has a volume of gas dissolved in it proportional to an equilibrated pressure, P_{eq}, which is the pressure under which gas is exposed to a liquid and becomes generally equilibrated with the liquid. Assuming the liquid is exposed to the gas at P_{eq} for a sufficient period of time, the liquid becomes generally saturated with dissolved gas. In many industrial process applications, P_{eq} will be equal to atmospheric pressure.

As shown in FIG. 1, the liquid in fluid container 14 is subjected to an initial pressure, Pᵢ, inside fluid container 14. In certain embodiments Pᵢ is generally equivalent to P_{eq}, while in other embodiments Pᵢ is greater than or less than P_{eq}. As the liquid enters inlet end 20 and flows through flow path 18 to outlet end 22, the liquid is subjected to a flow pressure, P_{f}, which represents the flow pressure at a given point in the flow path. P_{f} varies along flow path 18 between inlet end 20 and outlet end 22 to form a pressure gradient that causes the liquid to flow from inlet end 20 to outlet end 22.

A drop in the pressure of a saturated liquid flowing through a liquid delivery system results in gas microbubbles forming in the liquid. The term “microbubble” herein is intended to include both (1) gas bubbles that are perceivable to the human eye without magnification and (2) gas bubbles that are too small to be perceived without magnification or other detection means. In the liquid delivery system of FIG. 1, microbubble formation generally occurs in flow path 18 when P_{f} falls below P_{eq}. A drop in pressure to less than P_{eq} decreases the solubility of gas in the liquid, causing the liquid to become super-saturated, and thereby causing dissolved gas to come out of solution and form microbubbles. Thus, a key feature of the present invention is maintaining the pressure of the liquid in the flow path at a level that is generally at least as high as the pressure at which the liquid became equilibrated with gas. That is, a key feature of the present invention is maintaining P_{f} at a level generally equal or greater than P_{eq}. In many industrial process applications, this means preventing the pressure of the liquid from falling below atmospheric pressure.

Certain embodiments of the present invention may include a pump in the flow path to meter and/or assist the flow of liquid through the flow path. FIG. 2 is a block-diagram representation of the liquid delivery system of FIG. 1, in which flow path 14 includes a pump 24. In certain configurations of the liquid delivery system, pump 24 generally establishes a P_{f} on suction-side 26 of flow path 18 that is less than Pᵢ. For example, when fluid container 14 is located at an elevation lower than pump 24, or when sufficient friction is present within flow path 18, a P_{f} less than Pᵢ must be established to cause liquid to flow along flow path 18 from fluid container 14 to pump 24. If in doing so, P_{f} falls below P_{eq}, microbubbles may form in the liquid in flow path 18. As such, the present invention is directed towards inhibiting such microbubble formation by preventing P_{f} from generally falling below P_{eq}.

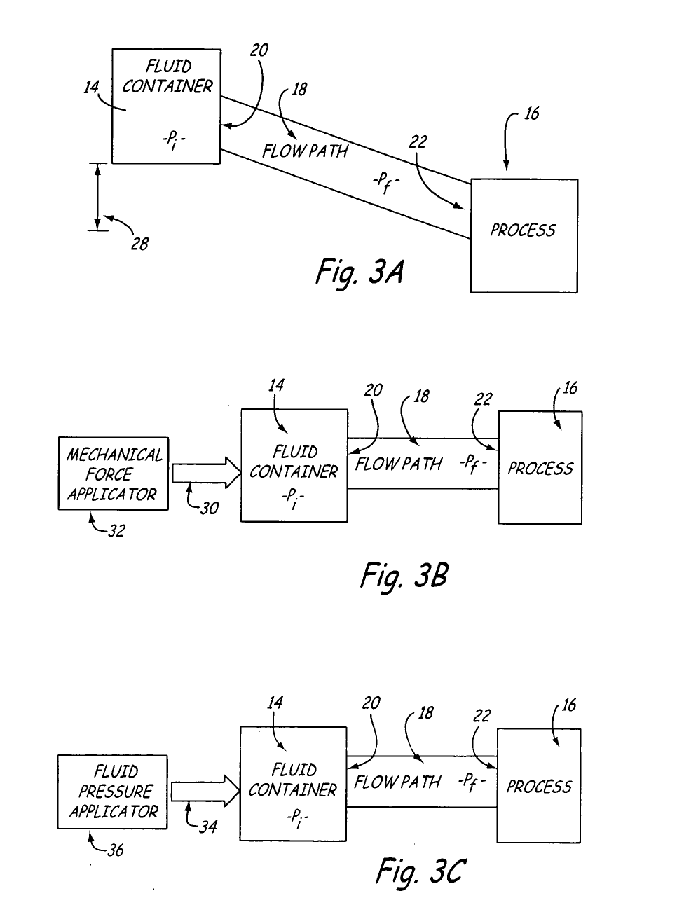

FIGS. 3A-3C show different examples of the liquid delivery system of FIG. 1 that prevent P_{f} from falling below P_{eq}. In FIG. 3A, fluid container 14 is elevated a distance 28, relative to flow path 18, to prevent P_{f} from falling below P_{eq}. For example, in industrial process applications where P_{eq} is equal to atmospheric pressure, elevating fluid container 14 by distance 28 prevents P_{f} from generally falling below atmospheric pressure. Thus, in one embodiment of the present invention, microbubble formation is inhibited by elevating the fluid container relative to the other parts of the liquid delivery system. For example, if P_{eq} is equal to atmospheric pressure, the elevation creates a positive hydraulic head that acts as a buffer to absorb pressure decreases in the flow path so P_{f} does not fall below atmospheric pressure.

In many industrial process applications, however, it may not be practical to elevate the fluid container relative to the flow path. Thus, an additional embodiment of the present invention is a method and a system for mimicking the effects of positive hydraulic head without actually elevating the fluid container. The method involves applying pressure to the liquid inside the fluid container to increase the pressure of the liquid. The pressure may be applied in any manner that elevates the pressure of the liquid inside the fluid container.

FIGS. 3B and 3C each illustrate a method and a system for mimicking the effects of positive hydraulic head. In both FIGS. 3B and 3C, microbubble formation is inhibited by raising Pᵢ above P_{eq} to prevent P_{f} from falling below P_{eq}. FIG. 3B shows a mechanical force 30 applied to fluid container 14 by a mechanical force applicator 32 to raise Pᵢ to simulate the effect of elevating fluid container 14. Examples of suitable mechanical force applicators include a piston or a plunger. In some embodiments, the mechanical force applicator may define a portion of an interior volume of the fluid container for holding liquid. A feature of the liquid delivery system of FIG. 3B is that, in some embodiments, the application of a direct mechanical force to the fluid container allows for precise measurement of the volume of liquid remaining inside the fluid container.

FIG. 3C shows a fluid pressure 34 applied to fluid container 14 by a fluid pressure applicator 36 to raise Pᵢ to simulate the effect of elevating fluid container 14. Fluid pressure, as used herein, is intended to include gas pressure, hydraulic pressure, or combinations thereof.

If headspace gas is present inside the fluid container when Pᵢ is made greater than P_{eq}, the increased pressure will drive additional gas into solution and microbubbles may form if the pressure subsequently falls below Pᵢ. Thus, when Pᵢ is greater than P_{eq}, fluid container 14 is preferably free of headspace gas. As such, in one embodiment of the present invention, the fluid container preferably has no headspace. Accordingly, the zero headspace fluid containers and filling techniques in U.S. patent application Ser. No. 10/139,185 (Publication No.2003/0205285) filed on Nov. 6, 2003 and entitled “Apparatus and Method for Minimizing the Generation of Particles in Ultrapure Liquid” are incorporated by reference. Additional means for generally achieving zero headspace are discussed later in further detail.

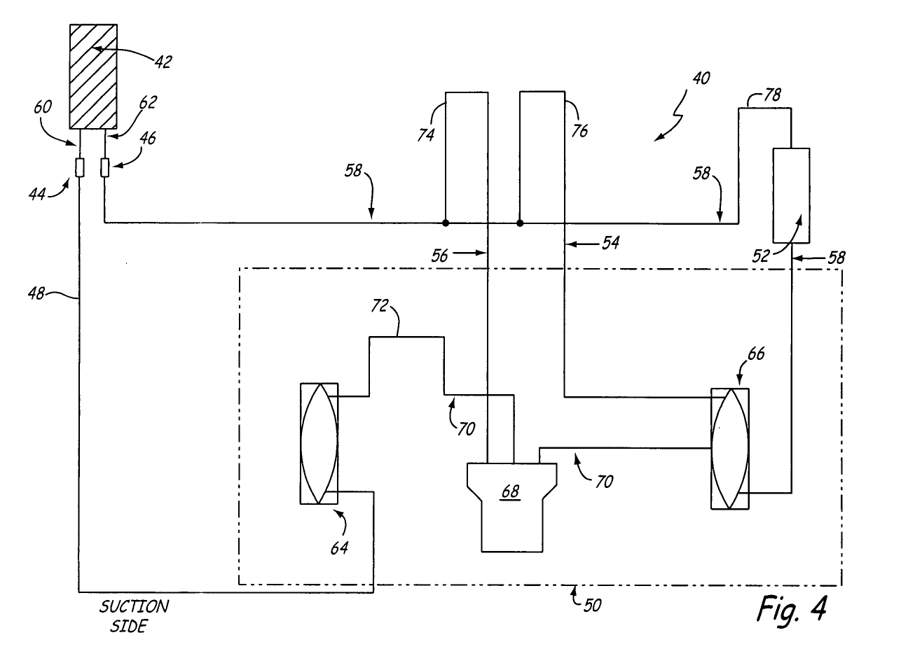

To test the ability of the present invention to inhibit microbubble formation, the following experiments were conducted. All of the experiments involved circulating a liquid saturated with gas through a closed liquid delivery system, while subjecting the liquid to different pressure conditions, to determine whether pressure changes influence microbubble formation in liquid flow paths. FIG. 4 shows a schematic representation of an experimental liquid delivery system 40 that was used in the initial experiment. Liquid delivery system 40 includes a fluid container 42, quick connects 44 and 46, a feed line 48, a pump 50, a particle counter 52, a purge line 54, a vent line 56, and a return line 58. Liquid delivery system 40 is generic in its construction. As such, any findings involving the nature of microbubble formation in the experimental apparatus are generalizable to most liquid delivery systems.

Liquid delivery system 40 differs from a typical liquid delivery system because instead of delivering liquid through a flow path from a fluid container to a downstream process, the liquid is circulated through the delivery system and returned to the fluid container. As such, liquid delivery system 40 constitutes a “closed” system. Liquid delivery system 40 also constitutes a “closed” system because, as described later, it may be configured to prevent both the infiltration of outside gas and the escape of gas from inside the system. The closed nature of liquid delivery system 40 allowed the effects of pressure changes on microbubble formation to be studied in the context of a fixed quantity of gas.

To make it easier to observe any outgassing of dissolved gas in liquid delivery system 40 due to pressure changes, it was desirable to use a test fluid capable of dissolving a substantial amount of gas. The reason for desiring such a test fluid is that the greater the total amount of gas dissolved in the test fluid, the larger the potential driving forces for outgassing, especially given the high likelihood that non-uniform concentration gradients will form in the circulated test fluid. If such non-uniformities were not allowed to exist, the solubility of gas in the test fluid would not matter. However, since non-uniformities can exist within test apparatus, the larger the solubility of the test fluid, the greater the mass transfer driving forces, which makes it easier to observe microbubble phenomena. Thus, it was desirable to select a test fluid for use with liquid delivery system 40 that had a high gas solubility.

In many solvents, for example water and isopropyl alcohol, an inverse correlation exists between the amount of gas dissolved in the solvent at equilibrium and the surface tension of the solvent. Since published data for surface tensions and solubility constants is not readily available for solvents other than water, the equilibrium solubilities for six organic solvents were calculated. The six organic solvents selected were isopropyl alcohol (IPA) and five photoresist casting solvents used in the microchip manufacturing industry. The gas solubilities for these solvents were calculated by first determining the surface tension for each solvent and then calculating the gas solubilities based on these surface tensions.

The resulting surface tensions and equilibrium gas solubilities for the six solvents are shown below in Table 1, with water data included for comparison. Using the density of the solvents, the molecular weights of the solvents, and the Sugden parachor, the McLeod-Sugden method was employed to calculate the surface tensions shown in the second column of Table 1. The equation used for these calculation is given below:

$$σ = {( \frac{[ P ] ρ}{M} )}^{4} ,$$

where σ is the surface tension in dynes/cm, [P] is the Sugden parachor of the solvent atom, ρ is the solvent density in g/ml, and M is the molecular weight of the solvent in g/mole.

The surface tensions were then used to calculate the solubility of gas in each solvent. Atmospheric air was selected as the gas for study because, given its ubiquitousness, it is the gas composition most likely to be dissolved in industrial liquid delivery systems. The composition of air was treated as a weighted average of 21% oxygen and 79% nitrogen. The resulting solubilities of air in each solvent are shown in the third column of Table 1, and are expressed in the form of the Ostwald coefficient for each solvent at 20° C. and 1 atm. The Ostwald Coefficient expresses the maximum amount of air that will dissolve in each ml of solvent under the above conditions.

TABLE 1

| | | Ostwald |
|---|---|---|
| | | Coefficient |
| | Surface Tension | (ml gas/ml |
| | at 20° C. | solution) |
| Solvent | (dynes/cm) | @ 20° C. |
| Water | 72.0 | 0.02 |
| Isopropyl Alcohol | 23.32 | 0.36 |
| CAS# 67-63-0 | | |
| 2-Heptanone | 26.17 | 0.30 |
| CAS# 110-43-0 | | |
| Cyclohexanone | 35.05 | 0.16 |
| CAS# 108-94-1 | | |
| Proyleneglycol monomethyl | 25.63 | 0.31 |
| ether acetate | | |
| CAS# 108-65-6 | | |
| Ethyl Lactate | 35.2 | 0.155 |
| CAS# 97-64-3 | | |
| g-Butyrolactone | 57.74 | 0.0375 |
| CAS# 96-48-0 | | |

According to the results in Table 1, air is most soluble in isopropyl alcohol (IPA). In consideration of this finding, a recipe of 70% IPA and 30% ethyl lactate (EL) was selected for the test fluid. Similarly, this composition was also selected because it had been observed to be particularly susceptible to microbubble formulation when dispensed from liquid delivery systems. A 500 ml volume of the test fluid was prepared in an open container by mixing 150 ml of EL with 350 ml of IPA in an environment of atmospheric pressure and approximately 20° C. The test fluid was maintained under these conditions for 18 hours to reach equilibrium with the environmental conditions. As such, the P_{eq} of the test fluid was atmospheric pressure. Under these conditions, it is reasonable to presume that the test fluid became saturated with air. Thus, from the information in Table 1, a prorated solubility of 0.2985 ml air per ml of test fluid was calculated, meaning that approximately 0.180 grams of air should have been dissolved in the 500 ml volume of test fluid.

The particular fluid container 42 used in the experiment comprised a 500 ml intravenous bag measuring ten-inches tall by five-inches wide when laid flat. An intravenous bag was selected for use in the experiment because of its ability to be filled under near-zero-headspace conditions, thereby reducing the amount of headspace air initially trapped inside liquid delivery system 40.

As shown in FIG. 4, fluid container 42 has an outlet port 60 and an inlet port 62, with outlet port 60 mated to quick connect 44 and inlet port 62 mated to quick connect 46. The suction-side of pump 50 is in communication with the interior volume of fluid container 42 via feed line 48, quick connect 44, and outlet port 60. The dispense-side of pump 50 is in communication with the interior volume of fluid container 42 via return line 58, quick connect 46, and inlet port 62. Particle counter 52 is positioned along return line 58 on the downstream-side of pump 50. Thus, when pump 50 is activated, test fluid is drawn from the interior volume of fluid container 42 through outlet port 60, into feed line 48, and then into pump 50. Pump 50 then dispenses the test fluid into return line 58 and back into fluid container 42 by way of inlet port 62.

The particular pump 50 used in the experiment was a two-stage Mykrolis IntelliGen pump, although an Iwaki Tube-Phragm pump or other similar type of pump could have been used. Pump 50 includes a feed pump 64, a dispense pump 66, a filter 68, and a flow path 70. Pump 50 is a two-stage pump, in which feed pump 64 and dispense pump 66 are connected by flow path 70. Filter 68 is positioned along flow path 70 and is connected to vent line 56. Dispense pump 66 is connected to return line 58 and purge line 54.

Quick connects 44 and 46 are attached to ports 60 and 62 of fluid container 42. The quick connects used in the experiment were CPC Quick Connects, which are commercially available from the Colder Products Company, St. Paul, Minn. Using the quick connects, fluid container 42 was filled with 500 ml of the test fluid. Quick connect 44 was then connected to feed line 48. Prior to connecting fluid container 42 to liquid delivery system 40, the flow path of the system was generally filled with test fluid. As a precaution, the flow path was vented before running the experiment to purge any air trapped inside the system. Special care was taken to purge any air residing inside feed pump 64, dispense pump 66, and filter 68. As part of this venting process, quick connect 46 and an adjacent portion of attached return line 58 were detached from fluid container 42 and elevated above pump 50. Pump 50 was then run until generally all the air was vented from the system via quick connect 46. At that point, quick connect 46 was connected back to inlet port 62 of fluid container 42, thereby “closing” liquid delivery system 40. Except for a small and finite volume of air introduced upon reconnecting quick connect 46 (which was allowed to settle to the top of fluid container 42) liquid delivery system 40 was essentially free of headspace air.

After achieving a closed system, liquid delivery system 40 was configured so that a subatmospheric pressure would not develop inside the system. To ensure that the pressure of the test fluid did not fall below atmospheric pressure at any location inside the flow path of liquid delivery system 40, fluid container 42 was hung from the ceiling to yield approximately 5 feet of hydraulic head advantage relative to pump 50. Due to the positive head, microbubble formation was not expected since the pressure of the test fluid would generally not fall below the atmospheric pressure at which the test fluid had been saturated with air. In other words, microbubble formation was not expected because P_{f} would not generally fall below P_{eq}, As such, the test fluid was not expected to reach a super-saturated state.

Even so, gas traps 72, 74, 76, and 78 were created in the form of tube loops located in the flow path of liquid delivery system 40 to act as traps for microbubbles, thereby making microbubble observation easier. Pump 50 was set to dispense its maximum volume, 6 ml, over a 6 second span and then recharge, purge, and vent in preparation for the next 6 ml/6 sec dispense. This resulted in a 36 second pump duty cycle with 6 seconds of dispense though lines 54, 56, and 58 and 30 seconds of recharge. In so far as steady state could be achieved in a pulsing duty cycle system, particle counts were recorded by particle counter 52 after the pump had run for 50 cycles. Particle counter 52, as used in the experiment, was a LiQuilaz S05 liquid particle counter commercially available from Particle Measuring Systems, Boulder, Colo.

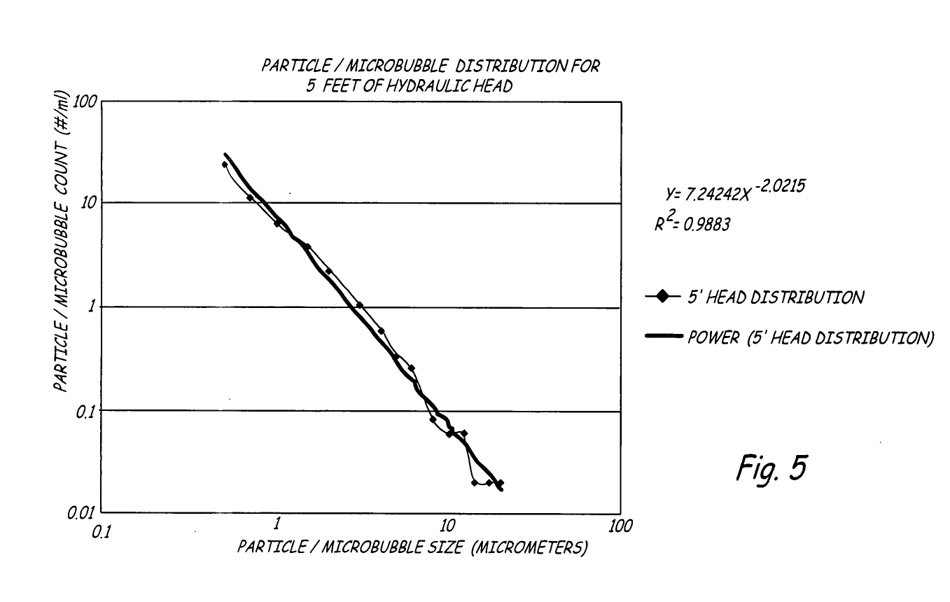

No microbubbles were observable to the naked eye at any of gas traps 72, 74, 76, and 78. The distribution of particles and microbubbles in the test fluid, as recorded by particle counter 52, also indicated that microbubbles were not forming. FIG. 5 shows a plot of this particle/microbubble distribution on a log-log scale. The slope of the distribution from this plot is −2.0215, which is within the −2.0 to −3.0 slope range expected for a typical semiconductor DI water facility. Thus, the particle/microbubble distribution in FIG. 5 is a good indication that microbubbles did not form in the system. Moreover, if microbubbles did form, the microbubbles followed a typical hard particle distribution, which is not thought to be common for this phenomena.

Liquid delivery system 40 was then reconfigured so the pressure would fall below atmospheric pressure on the suction-side of pump 50 between feed pump 64 and fluid container 42. This pressure environment was achieved by placing the liquid-filled fluid container 42 at floor level, approximately three feet below the level of pump 50, thereby creating approximately three feet of negative hydraulic head. In this configuration, P_{f} falls below the atmospheric P_{eq} on the suction-side of pump 50 between fluid container 42 and feed pump 64. A subatmospheric P_{f} forms because, given the negative head, pump 50 must establish a subatmospheric pressure to induce test fluid to flow from fluid container 42 up to pump 50.

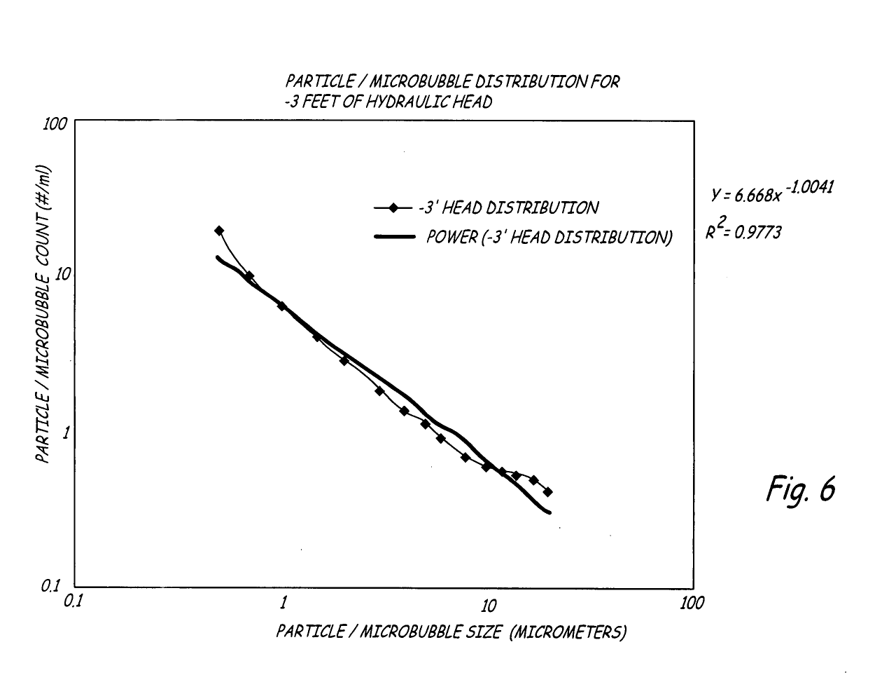

After reestablishing flow of the test fluid through liquid delivery system 40, newly-formed microbubbles were observed by the naked eye in gas trap 72 between feed pump 64 and filter 68. Newly-formed microbubbles were also observed in downstream gas traps 74, 76, and 78. The distribution of particles and microbubbles in the test fluid, as recorded by particle counter 52, provided further indication of microbubble formation. This particle/microbubble distribution is shown in FIG. 6 plotted on a log-log scale. The slope of the distribution is approximately −1.0041, which is outside the range expected for a typical semiconductor DI water facility. Moreover, the slope of the particle/microbubble distribution shifted significantly from the slope of about −2.0 in FIG. 5. As such, both the visual observations and the particle/microbubble distribution support the finding that a subatmospheric pressure contributed to microbubble formation.

To test whether the microbubble formation was reversible, fluid container 42 was moved from the floor back up to the ceiling, reestablishing approximately five feet of positive hydraulic head. After elevating fluid container 42, the microbubbles residing in the gas traps dissolved back into the test fluid, leaving no observable microbubbles in liquid delivery system 40. As such, the above positive and negative hydraulic head experiments indicate that a subatmospheric pressure in a liquid delivery system contributes to the formation of microbubbles. That is, the experiments indicate that a P_{f} below P_{eq} contributes to microbubble formation.

In the negative head experiment, the possibility that the observed microbubbles were caused by the subatmospheric pressure on the suction-side of pump 50 sucking air into the flow path can be dismissed. The observed microbubble formation was completely reversible when the fluid container was elevated to establish a positive hydraulic head. If infiltration of air into liquid delivery system 40 had occurred, the air would not have completely dissolved back into solution since the test fluid was generally saturated with air prior to filling the fluid container. As such, the test results indicate that the total mass of air in the system did not increase, which eliminates the possibility that air infiltration induced the microbubble formation.

Therefore, the above experiments demonstrate that a region of subatmospheric pressure (which in this case is below P_{eq}) in a liquid delivery system contributes to the formation of microbubbles. Thus, in one embodiment of the present invention, a subatmospheric pressure is prevented from occurring in a liquid delivery system by elevating the fluid container. By elevating the fluid container relative to the other parts of the liquid delivery system, a positive hydraulic head is created which acts as a buffer to absorb pressure decreases without the pressure reaching subatmospheric levels.

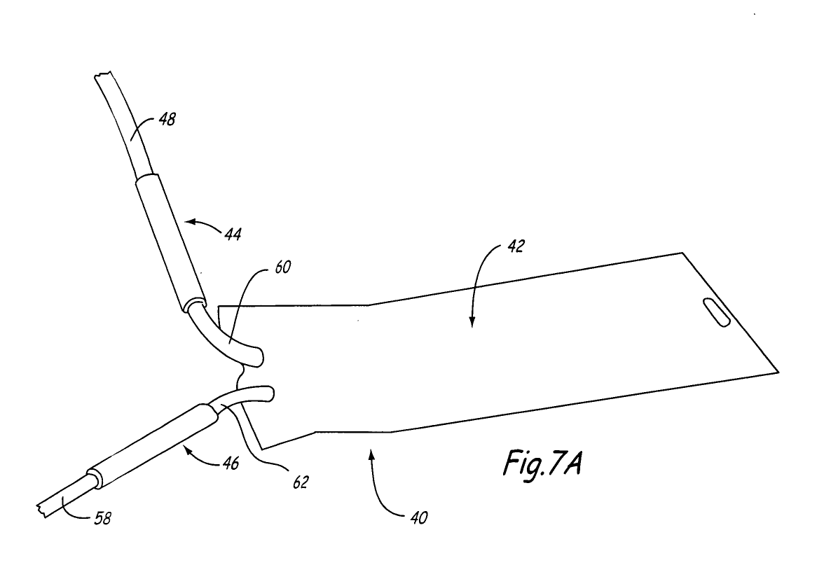

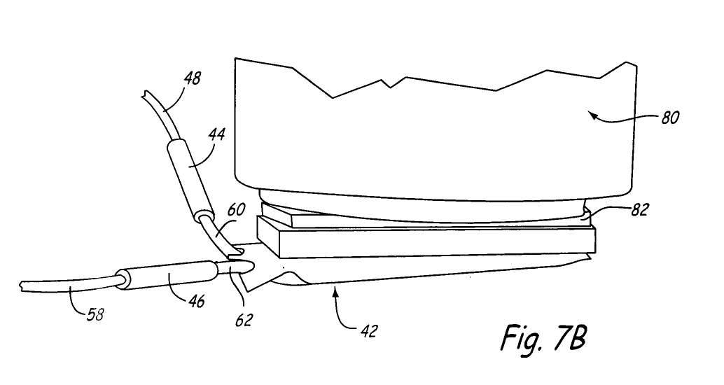

Since in many industrial process applications it may not be practical to elevate the liquid source, systems and methods for applying pressure to the fluid container to mimic the effects of elevation were studied. FIGS. 7A and 7B illustrate one such system and method for applying a pressure to liquid in a fluid container. FIG. 7A shows a portion of liquid delivery system 40 of FIG. 4 proximate to fluid container 42, while FIG. 7B shows the same portion of liquid delivery system 40 except a dead weight 80 has been placed atop fluid container 42. More specifically, FIG. 7B shows an example of the mechanical force applicator of FIG. 3B.

The system and method of FIGS. 7A and 7B for applying pressure to the liquid in fluid container 42 is best illustrated in the context of an additional experiment. Fluid container 42 again constitutes a flexible 500 ml intravenous bag with a 5 inch-wide by 10 inch-long flat dimension. Unlike the previously described experiments, however, the intravenous bag was located at approximately the same elevation as the rest of liquid delivery system 40. As such, liquid delivery system 40 had generally neither a positive nor a negative hydraulic head.

The intravenous bag was filled with 500 ml of a 70% IPA and 30% EL test fluid equilibrated at 1 atm and 20° C. to become saturated with dissolved air. The filled intravenous bag was then turned upside down and the residual air in the bag was ejected out of ports 60 and 62. As in the positive and negative head experiments, liquid delivery system 40 was initially purged of any residual air trapped inside the system. The system was then closed off so air could neither exit or infiltrate the system. Flow was induced in the system using pump 50. Microbubble formation was subsequently observed in the flow path of liquid delivery system 40.

As shown in FIG. 7B, a flat intermediate support plate 82 was then placed atop the intravenous bag, which was laid flat in a horizontal orientation. Dead weight 80 was positioned atop the intermediate support plate 82. Dead weight 80 had a total weight of 100 pounds, all of which was supported by the intravenous bag. As a result, dead weight 80 exerted a pressure of approximately 2 psi, or 100 lbs/50 in², which, given the density of the IPA:EL test fluid, equated to approximately the same pressure supplied by 5 feet of elevation. After the addition of dead weight 80, the microbubbles dissolved back into solution until none were visible. Dead weight 80 was then removed from atop the intravenous bag and, microbubble formation was again observed. This process was repeated numerous times and was highly reproducible. Microbubbles formed each time dead weight 80 was removed, only to dissolve back into solution and disappear once dead weight 80 was reapplied. Therefore, the experiment both (1) indicated that applying a pressure to a liquid inside a fluid container with generally zero headspace prevents microbubble formation and (2) further confirmed that subatmospheric pressures contribute to microbubble formation in liquid delivery systems where the liquid was equilibrated with gas under atmospheric pressure.

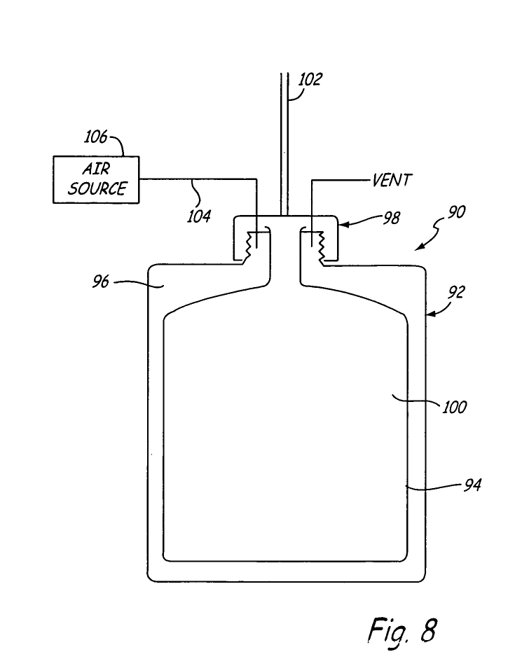

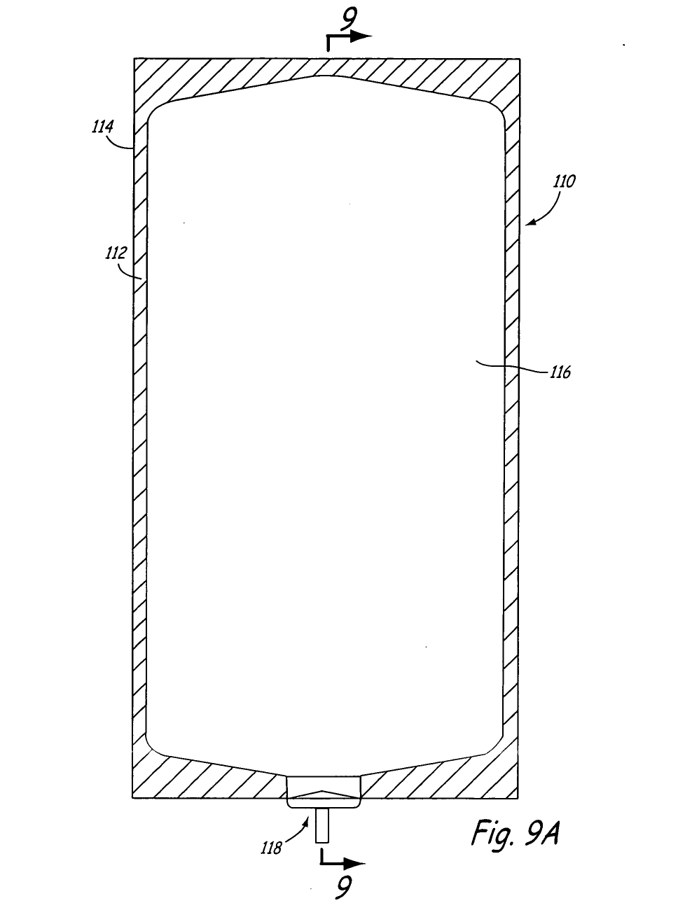

FIG. 8 illustrates an additional embodiment of the present invention, in which the effects of an elevated fluid container are simulated by increasing the pressure in an interior volume of a fluid container. FIG. 8 shows a fluid container 90 that comprises a rigid outer container 92, a collapsible liner 94, an intermediate area 96, and a fitment 98. Fitment 98 seals off intermediate area 96 from the external environment of the fluid container. In addition, fitment 98 also seals off an interior volume 100 of collapsible liner 94 from intermediate area 96 and the external environment. Fitment 98 is connected to a dispense line 102 in which liquid flows, with or without the aid of a pump, from inside collapsible liner 94 to a downstream process, which is not shown. Fitment 98 accommodates an air supply line 104, which passes through fitment 98 and communicates with intermediate area 96. Air supply line 104 is connected to an air source 106 that may be located external to the fluid container, although air source 106 may also be located inside fluid container 90.

Collapsible liner 94 is preferably filled with liquid under zero headspace conditions to inhibit subsequent microbubble formation due to pressure drops. Furthermore, collapsible liner 94, is preferably constructed from a flexible material that is impermeable to gas transfer, thus preventing air from infiltrating interior volume 70 when intermediate area 96 is pressurized. When collapsible liner 94 is filled with liquid, air from air source 106 may be supplied through air supply line 104 to pressurize intermediate area 96 and displace liquid from interior volume 100 into dispense line 102. The liquid displaced into dispense line 102 has a pressure greater than atmospheric pressure, decreasing the likelihood of downstream microbubble formation. Fluid container 90 has the additional feature that it eliminates the need for a downstream pump in certain liquid delivery systems since the fluid container is capable of inducing flow without the assistance of a downstream pump.

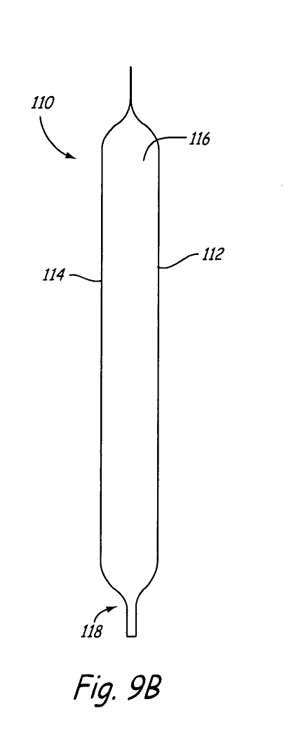

FIGS. 9A and 9B show a collapsible liner 110 that may be filled under zero headspace conditions and used in a liquid delivery system as a fluid container or a component of a fluid container, with FIG. 9A showing a front view of collapsible liner 110 and FIG. 9B showing a cross-section of collapsible liner 110 along line 9-9. Collapsible liner 110 may be housed inside a rigid outer container to protect the liner and prevent leakage of liquid into the surrounding environment in the event of a structural failure of liner 110.

Collapsible liner 110 may be formed by folding over a flexible sheet material to form a top film 112 and a bottom film 114. The peripheral edges of films 112 and 114 are sealed to form an interior volume 116 for holding liquids. The sealed together portions of films 112 and 114 are represented by hatched lines in FIG. 9A. The shape of interior volume 116 is determined by the portions of films 112 and 114 that are sealed together. Films 112 and 114 are preferably constructed from material that has the tendency to stick tightly to prevent air from being trapped inside interior volume 116. In addition, a static charge may be imparted to the films to improve the attraction between films 112 and 114.

A fitment 118 may be sealed to collapsible liner 110 to define a port communicating with interior volume 116. Such a port may be used to supply liquid into interior volume 116, and may also be used to evacuate air trapped inside interior volume 116. In addition, fitment 118 may be used to dispense liquid from interior volume 116 into a flow path, or alternatively, additional fitment(s) may be included for such purposes. Moreover, each fitment may define a plurality of ports and may be located anywhere on the fluid container capable of communicating with the interior volume. Another feature of collapsible liner 110 is that it can hold a variable amount of liquid, thereby providing a versatile package for use in industrial process applications.

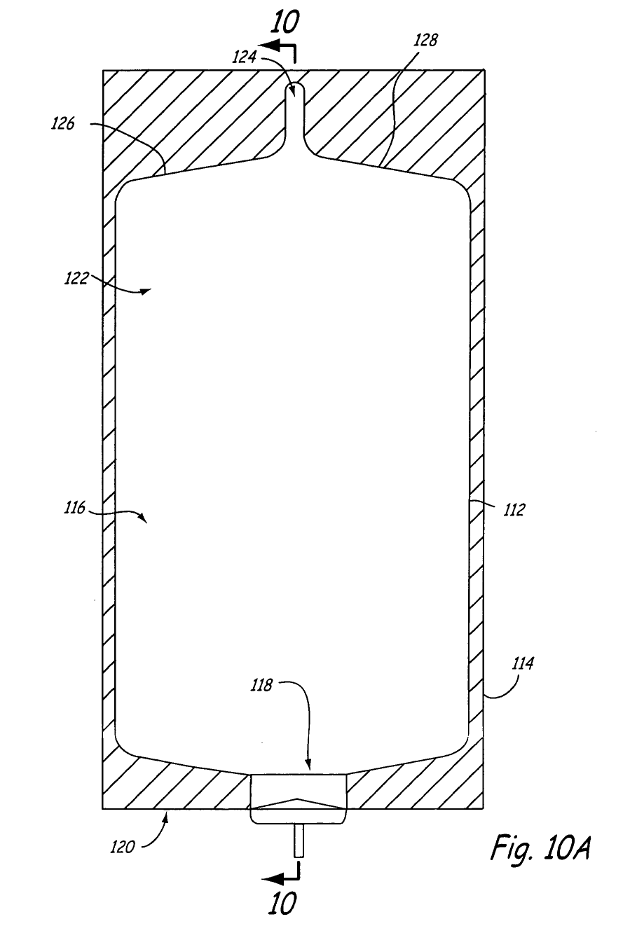

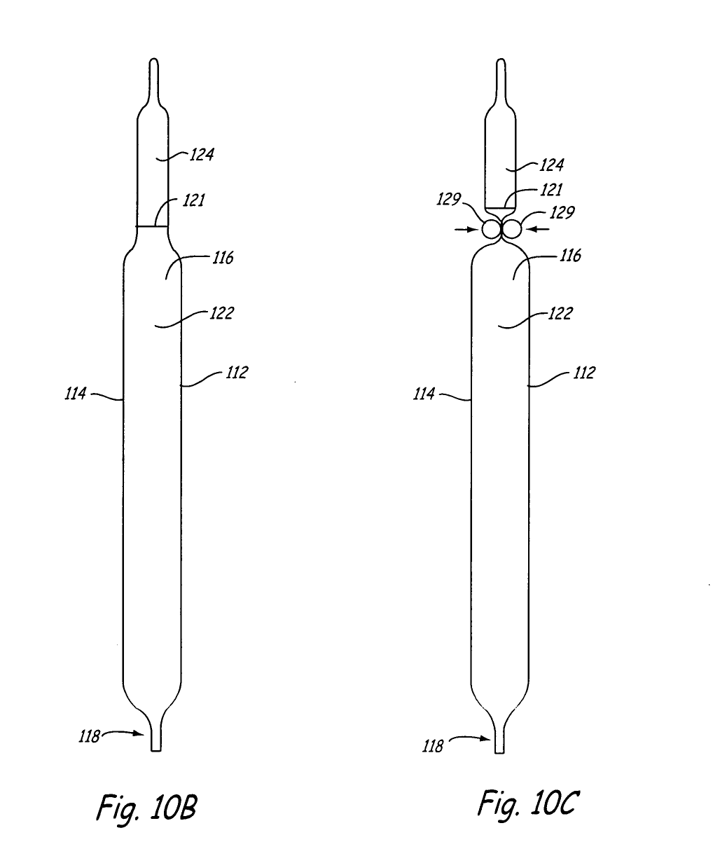

FIGS. 10A-10C show an additional embodiment of a collapsible liner 120 for use in the liquid delivery system of the present invention, with FIG. 10A showing a front view of collapsible liner 120, FIG. 10B showing a cross-section taken along line 10-10 of FIG. 10A after filling collapsible liner 120 with liquid and prior to sealing off a gas-trapping auxiliary chamber, and FIG. 10C showing a cross-section taken along line 10-10 of FIG. 10A after filling collapsible liner 120 with liquid and sealing off the gas-trapping auxiliary chamber. Collapsible liner 120 is similar to collapsible liner 110 of FIGS. 9A-9B, except collapsible liner 120 has an additional feature that allows headspace gas to be segregated from liquid inside collapsible liner 120 by controlling a gas/liquid interface 121 as shown in FIGS. 10B and 10C.

Like collapsible liner 110, collapsible liner 120 has a top film 112 and a bottom film 114 that define an interior volume 116 for holding liquid, with the peripheral portions of films 112 and 114 sealed together as represented by hatched lines in FIG. 10A. However, interior volume 116 of liner 120 has a main chamber 122 and a gas-trapping auxiliary chamber 124 connected to main chamber 122. Main chamber 122 has tapered walls 126 and 128, which taper towards auxiliary chamber 124. Collapsible liner 120 may include a fitment 118, or a plurality of fitments, to communicate with interior volume 116. Collapsible liner 120 may be formed using the methods described above for collapsible liner 110, or any other suitable method of manufacture known in the art.

When a generally zero headspace condition is desired inside interior volume 116, interior volume 116 is first filled with a quantity of liquid sufficient to completely fill main chamber 122. Collapsible liner 120 is then preferably oriented so auxiliary chamber 124 has the highest elevation. This orientation encourages headspace gas to congregate inside auxiliary chamber 124. The inclusion of tapered walls 126 and 128 further facilitates this gas migration. As shown in FIGS. 10B and 10C, after interface 121 is located inside auxiliary chamber 124 and main chamber 122 is generally devoid of headspace gas, auxiliary chamber 124 is pinched off or sealed off from main chamber 122 below interface 121 to trap headspace gas within auxiliary chamber 124. This isolates the gas in auxiliary chamber 124 away from the liquid inside main chamber 122. Any suitable means may be used to seal off main chamber 122 from auxiliary chamber 124. In one embodiment, a pinch mechanism 129 is used to seal off the two chambers.

The auxiliary chamber may be sealed off after connecting the main chamber of the interior volume to the flow path, thereby removing any headspace gas introduced as a result of the connection. Collapsible liner 120, thus, provides a convenient means for obtaining a generally zero-headspace fill.

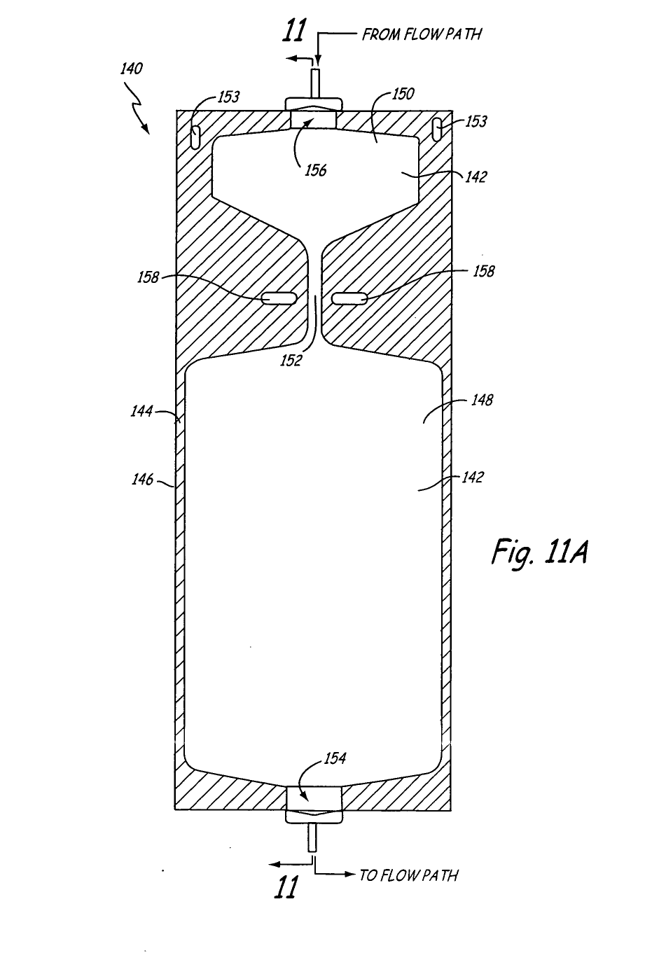

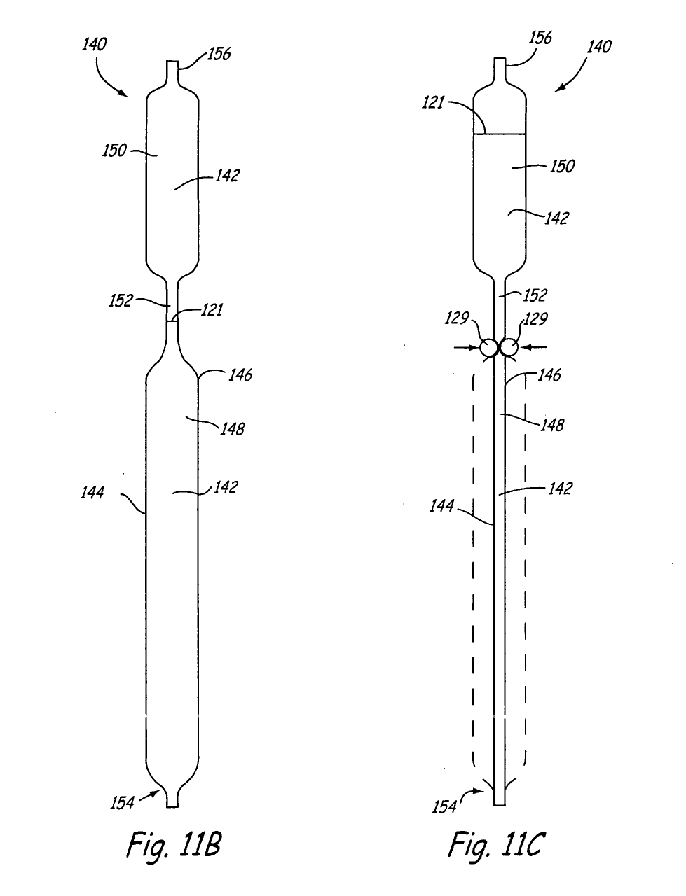

FIGS. 11A-11C show an additional embodiment of the fluid container of the present invention, which allows liquid and/or headspace gas to be collected from an outlet of a flow path of a liquid delivery system. FIG. 11A shows a front view of a collapsible liner 140; FIG. 11B shows a cross-section of collapsible liner 140 taken along line 11-11 of FIG. 11A after filling a dispensing chamber with liquid and before sealing off a collection chamber; and FIG. 11C shows a cross-section of collapsible liner 140 taken along line 11-11 of FIG. 11A after sealing off the collection chamber, dispensing the liquid from the dispensing chamber, and collecting the liquid in the collection chamber. Like collapsible liner 120, collapsible liner 140 may be used as a fluid container for a liquid delivery system or as a component of such a fluid container.

Collapsible liner 140 has an interior volume 142 defined by a top film 144 and a bottom film 146, which are sealed together as represented by the hatched lines in FIG. 11A. Interior volume 142 includes a main dispensing chamber 148, an auxiliary collection chamber 150, and a passage 152 connecting dispensing chamber 148 and collection chamber 150. In one embodiment, the walls of dispensing chamber 148 and collection chamber 150 are tapered towards passage 152. Hanging holes 153 may be formed in films 144 and 146 to receive supports to allow collapsible liner 140 to be vertically suspended.

Collapsible liner 140 may be formed pursuant to the methods described above for collapsible liner 120. Portions of films 144 and 146 are sealed together to form interior volume 142, with the hatched lines in FIG. 11A representing the sealed together portions of films 144 and 146. The two films may be sealed around the entire periphery where the two films meet or, alternatively, one or more regions of the periphery may be left unsealed to accommodate any number of fitments.

Fitments 154 and 156 are sealed to collapsible liner 140 to define ports communicating with interior volume 142. Fitment 154 is located at an end of dispensing chamber 148 opposite collection chamber 150, and fitment 156 is located at an end of collection chamber 150 opposite dispensing chamber 148. In other embodiments, any number of fitments with any number of ports may be sealed to collapsible liner 140 at any location or locations that allow access to interior volume 142.

Similar to collapsible liner 120, collapsible liner 140 may be configured to achieve a zero headspace condition. Passage 152 may be sealed off to terminate communication between dispensing chamber 148 and collection chamber 150 and isolate headspace gas within collection chamber 150. A zero-headspace condition may be obtained inside dispensing chamber 148 using the methods described above for collapsible liner 120. For example, as shown in FIG. 11B, collapsible liner 140 is filled and oriented so interface 121 between the liquid and the headspace gas is located within passage 152, which is then pinched off below interface 121 similar to collapsible liner 120 in FIG. 10C. As such, collection chamber 150 may be used as a gas-trapping chamber similar to auxiliary chamber 124 of collapsible liner 120. In one embodiment, clamping holes 158 are provided in films 144 and 146 for insertion of a clamping device to seal off passage 152.

Fitments 154 and 156 may be mated, respectively, with an inlet end of a flow path and an outlet end of a flow path, thereby placing each fitment in communication with the flow path. In this configuration, liquid in dispensing chamber 148 may be dispensed into the flow path and liquid from the flow path may be collected in collection chamber 150. FIG. 11C shows collapsible liner 140 with liquid collected in sealed off collection chamber 150 after liquid was dispensed from dispensing chamber 148. The broken lines in FIG. 11C represent the cross-section of dispensing chamber 148 prior to dispensing the liquid. The liquid collected in collection chamber 150 may be saved for later use or discarded. As such, collection chamber 150 may function as a storage reservoir or a waste reservoir. In particular, collection chamber 150 may be used to receive liquid used to purge headspace gas or other contaminants from the flow path.

The liquid collected in collection chamber 150 may be drained into dispensing chamber 148 by unsealing passage 152. If the liquid is to be dispensed back into the flow path, the liquid should preferably be allowed to equilibrate within collection chamber 150 before being drained back into dispensing chamber 148, thereby reducing the amount of dissolved gas in the liquid and discouraging microbubble formation.

An additional feature of the present invention is its ability to discourage cavitation of a fluid traveling through a liquid delivery system. This characteristic is important because cavitation can lead to microbubble formation in liquid delivery systems. Cavitation occurs when a liquid flows into a region where its pressure is reduced to its vapor pressure, causing the liquid to boil and form gaseous vapor pockets. For example, for water at 20° C., the vapor pressure for the water is approximately 0.023 atm, meaning that when the pressure of the water drops to approximately 0.023 atm, the water begins to boil and develop gaseous vapor pockets. Subatmospheric pressures in liquid delivery systems, for example on the suction-side of a pump, may be sufficient to induce cavitation. Thus, by ensuring that the pressure of water in a liquid delivery system remains above atmospheric pressure, cavitation-induced microbubble formation is inhibited. In general, the present invention helps prevent cavitation-induced microbubble formation in liquids that have a vapor pressure below atmospheric pressure. In addition, the present invention also helps prevent cavitation of liquids that have vapor pressures in excess of atmospheric pressure, depending upon the proximity of the particular vapor pressure to atmospheric pressure.

Although the present invention has been described with reference to preferred embodiments, workers skilled in the art will recognize that changes may be made in form and detail without departing from the spirit and scope of the invention.

1. A method for delivering liquid from a fluid container to a downstream process, the downstream process for depositing the liquid on a substrate, the method comprising:
supplying the liquid from the fluid container into a flow path; and
delivering the liquid through the flow path to the downstream process while maintaining the liquid in the flow path at a pressure that inhibits formation of microbubbles in the liquid.

2. The method of claim 1, wherein the method further comprises establishing a zero-headspace condition in the fluid container.

3. The method of claim 1, wherein the method further comprises removing headspace gas from the liquid.

4. The method of claim 3, wherein headspace gas is removed by sealing a passage between a main chamber of the fluid container and an auxiliary chamber of the fluid container.

5. The method of claim 1, wherein supplying the liquid from the fluid container into the flow path comprises displacing liquid from the fluid container by reducing an interior volume of the fluid container filled with the liquid.

6. The method of claim 5, wherein a direct mechanical force is applied to the fluid container to reduce the interior volume of the fluid container.

7. The method of claim 5, wherein fluid pressure is used to reduce the interior volume of the fluid container.

8. The method of claim 7, wherein the fluid pressure is supplied to an intermediate volume of the fluid container, the intermediate volume located between a flexible liner and an outer portion of the fluid container.

9. The method of claim 1, wherein supplying the liquid from the fluid container into the flow path comprises elevating the fluid container with respect to the flow path.

10. The method of claim 1, wherein the substrate is a silicon wafer.

11. A system for delivering liquid to a downstream process that minimizes formation of microbubbles in the liquid, wherein the liquid is used in the downstream process to process microstructures, the system comprising:
a fluid container for storing the liquid; and
a flow path comprising:
an inlet end connected to the fluid container, and
an outlet end connected to a downstream process;
wherein the fluid container is located at an elevation that is generally higher than the flow path.

12. The system of claim 11, wherein the system further includes a pump located in the flow path.

13. A system for delivering liquid to a downstream process that minimizes formation of microbubbles in the liquid, the system comprising:
a fluid container for storing the liquid;
a flow path comprising:
an inlet end communicating with the fluid container, and
an outlet end communicating with the downstream process; and
means for increasing a pressure inside the system to generally prevent the liquid from being subjected to a pressure that induces microbubble formation.

14. The system of claim 13, wherein the pressure increasing means positions the container to produce a positive hydraulic head.

15. The system of claim 13, wherein the pressure increasing means comprises a mechanical force applicator configured to apply a direct mechanical force to the fluid container.

16. The system of claim 15, wherein the mechanical force applicator defines a portion of an interior volume of the fluid container, the interior volume for storing the liquid.

17. The system of claim 13, wherein the pressure increasing means comprises a fluid pressure applicator, wherein the fluid pressure applicator raises the pressure inside the fluid container.

18. The system of claim 17, wherein the fluid container has an intermediate volume located between a flexible liner and an outer portion of the fluid container, the flexible liner defining an interior volume for storing the liquid.

19. The system of claim 13, wherein the fluid container has an interior volume for storing the liquid that comprises a main chamber and an auxiliary chamber connected to the main chamber.

20. The system of claim 19, wherein the interior volume is defined by a flexible liner.

21. The system of claim 19, wherein the auxiliary chamber is positioned relative to the main chamber to trap headspace gas.

22. The system of claim 19, wherein the auxiliary chamber is configured to receive liquid from the flow path.

23. The system of claim 13, wherein the liquid is used in the downstream process to process microstructures.

24. A method for delivering liquid from a fluid container along a flow path that minimizes formation of microbubbles in the liquid, the method comprising:
providing the fluid container filled with the liquid, wherein an amount of air dissolved in the liquid corresponds to an equilibration pressure; and
delivering the liquid along the flow path from the fluid container to an outlet end of the flow path, wherein the liquid is not subjected to a flow path pressure lower than the equilibration pressure.

25. The method of claim 24, wherein the equilibration pressure is atmospheric pressure.

26. The method of claim 24, wherein the liquid is delivered along the flow path from the fluid container by reducing an interior volume of the fluid container.

27. The method of claim 26, wherein the liquid is delivered along the flow path with assistance of a pump located in the flow path.

28. The method of claim 24, wherein the method further comprises establishing a zero-headspace condition prior to delivering the liquid along the flow path.

29. The method of claim 24, wherein the method further comprises removing headspace gas from the liquid prior to delivering the liquid along the flow path.

30. The method of claim 29, wherein the headspace gas is removed by sealing a passage between a main chamber of the fluid container and an auxiliary chamber of the fluid container.

31. The method of claim 24, wherein the method further comprises removing headspace gas from the flow path prior to delivering liquid to the outlet end of the flow path.

32. The method of claim 31, wherein the flow path has a port in communication with a collection chamber of the fluid container.

33. The method of claim 24, wherein the liquid is a chemical used in the processing of microstructures.
